(19) United States
(12) Patent Application Publication
(10) Pub. No.: US 2026/0078655 A1
(43) Pub. Date: Mar. 19, 2026

(54) METHOD TO IMPROVE CARBON CAPTURE AND STORAGE

(71) Applicant: DORF KETAL CHEMICALS FZE, Fujairah (AE)

(72) Inventor: Markus WEISSENBERGER, Calgary (CA)

(21) Appl. No.: 19/106,933

(22) PCT Filed: Sep. 12, 2023
(86) PCT No.: PCT/IB2023/059043

§ 371 Date: Feb. 26, 2025

(30) Foreign Application Priority Data
Sep. 19, 2022 (CA) 3174804

(51) Int. Cl. E21B 41/00; C09K 8/74

(52) U.S. Cl. CPC E21B 41/0064; C09K 8/74

(57) ABSTRACT

The present invention relates to a method to increase the volume of a wellbore, said method comprising:
providing a wellbore located within a rock formation;
providing a modified acid composition comprising at least two components: a first component being an amino acid and a second component being a mineral acid; wherein said first component and second component being present a molar ratio ranging from 1:2 to 1:12.5;
injecting said modified acid composition into said wellbore at a pressure below fracking pressure;
allowing the modified acid composition to be in contact with the formation for a period of time long enough to allow the modified acid to create a series of wormholes and consequently increase the surface area fluidly connected to said wellbore to enhance the absorption capacity of carbon dioxide injected into said wellbore.

### CROSS-REFERENCE TO RELATED APPLICATIONS

This application is a filing under 35 U.S.C. 371 as the National Stage of International Application No. PCT/IB2023/059043 filed Sep. 12, 2023 and entitled “Method to Improve Carbon Capture and Storage”, which claims priority Canadian Patent Application No. 3174804 filed Sep. 19, 2022, which are hereby incorporated by reference in their entirety.

### FIELD OF THE INVENTION

This invention is directed to a method to improve carbon capture and storage, more specifically, to a method to augment the volume of rock formations located proximate wells.

### BACKGROUND OF THE INVENTION

Given the urgent climate crisis, there is an immediate need of improving carbon capture and sequestration. Of the many approaches considered to reduce the amount of carbon dioxide in the atmosphere, one of those proposed involves the injection of the carbon dioxide into wells. This is referred to as geologic carbon storage. Either as a gas or a liquid saturated with carbon dioxide, injection into an abandoned well has elicited some interest in many parts of the world and many research groups have studied the ramifications of doing so and the impacts thereof. Many locations around the world have either implemented pilot-scale projects for CCS or have actually set up commercial scale plants. The commercial scale plants currently operating have a stated capacity of close to a million metric tons per year.

The mechanism of migration of carbon dioxide and subsequent sequestration has been studied and depends on flow, temperature and pressure of the gas injected.

However, to keep up with the seemingly never-ending need for sequestration of carbon dioxide, companies have resorted to drilling new wells. Such wells are typically well over a kilometer in length and can cross various rock formations. This is carried out to supplement the limited availability and capacity abandoned oil wells. A desirable approach would be to use available ground-based infrastructures (such as abandoned oil wells or the like) and treat them in order to increase their carrying capacity in terms of carbon dioxide absorption.

A wellbore (along with its near wellbore space) having an increased volumetric capacity (through an increased accessible surface area) is desirable as it can provide useful space to store carbon dioxide and prevent such from being released in the atmosphere.

It has surprisingly been found that a modified acid composition comprising an amino acid component and an acid component such as, but not limited to a compound selected from the group consisting of: a mineral acid and an organic acid, a combination of organic and inorganic acids has unexpected technical advantage to generate wormholes inside a rock formation. Compared to a mineral acid compositions such as hydrochloric acid, a modified acid composition as described herein is capable of providing a larger volumetric capacity (to store CO₂) increase of the wellbore and its proximate surrounding area, also referred to as the near wellbore space. In that respect, it becomes clear that if new wells are to be drilled for CO₂ storage or if abandoned wells are rehabilitated to be used for carbon storage, it is worthwhile ensuring that the wells have an optimal available volume for carbon sequestration without jeopardizing the rock formation adjacent to the well.

According to a preferred embodiment of the present invention, there is provided a method of matrix acidizing a formation where the surface area increases through wormholes created by acid injection vs prior to treatment and depth of penetration into the formation is optimized. Such optimization will preferably lead to a maximized carbon dioxide absorption and create valuable volume to store this greenhouse gas within the earth.

### SUMMARY OF THE INVENTION

According to an aspect of the present invention, there is provided a method to increase the volume of a wellbore, wherein said method comprises the steps of:
providing a wellbore located within a rock formation;
providing a modified acid composition comprising at least two components: a first component being an amino acid and a second component being a mineral acid wherein said first component and second component being present a molar ratio ranging from about 1:2 to about 1:12.5;
injecting said modified acid composition into said wellbore at a pressure below fracking pressure;
allowing the modified acid composition to be in contact with the formation for a period of time long enough to allow the modified acid composition to create a series of wormholes and consequently increase the surface area fluidly connected to said wellbore to enhance the absorption capacity of carbon dioxide injected into said wellbore.

Preferably, said amino acid is selected form the group consisting of: alanine, asparagine, aspartic acid, cysteine, glutamic acid, glycine, histidine, leucine, lysine, methionine, proline, serine, threonine or valine or combinations thereof.

According to a preferred embodiment of the present invention, said rock formation is selected from the group consisting of: limestone formation; dolomite formation and chalk formation.

According to the present invention, said rock formation is preferably a limestone formation.

According to a preferred embodiment of the present invention, said mineral acid is hydrochloric acid.

According to a preferred embodiment of the present invention, said alanine and hydrochloric acid are present in a molar ratio ranging from about 1:2 to about 1:12.5, preferably from about 1:4.5 to about 1:8.5.

According to a preferred embodiment of the present invention, said asparagine and hydrochloric acid are present in a molar ratio ranging from about 1:4 to about 1:12.5, preferably from about 1:6.5 to about 1:8.5.

According to a preferred embodiment of the present invention, said aspartic acid and hydrochloric acid are present in a molar ratio ranging from about 1:2 to about 1:12.5, preferably from about 1:4.5 to about 1:8.5.

According to a preferred embodiment of the present invention, said cysteine and hydrochloric acid are present in a molar ratio ranging from about 1:2 to about 1:12.5, preferably from about 1:4.5 to about 1:8.5.

According to a preferred embodiment of the present invention, said glutamic acid and hydrochloric acid are present in a molar ratio ranging from about 1:2 to about 1:12.5, preferably from about 1:4.5 to about 1:8.5.

According to a preferred embodiment of the present invention, said glycine and hydrochloric acid are present in a molar ratio ranging from about 1:2 to about 1:12.5, preferably from about 1:5.5 to about 1:8.5.

According to a preferred embodiment of the present invention, said histidine and hydrochloric acid are present in a molar ratio ranging from about 1:2 to about 1:12.5, preferably from about 1:4.5 to about 1:8.5.

According to a preferred embodiment of the present invention, said leucine and hydrochloric acid are present in a molar ratio ranging from about 1:2 to about 1:12.5, preferably from about 1:4.5 to about 1:8.5.

According to a preferred embodiment of the present invention, said lysine and hydrochloric acid are present in a molar ratio ranging from about 1:2 to about 1:12.5, preferably from about 1:4.5 to about 1:8.5.

According to a preferred embodiment of the present invention, said methionie and hydrochloric acid are present in a molar ratio ranging from about 1:2 to about 1:12.5, preferably from about 1:4.5 to about 1:8.5.

According to a preferred embodiment of the present invention, said proline and hydrochloric acid are present in a molar ratio ranging from about 1:2 to about 1:12.5, preferably from about 1:4.5 to about 1:8.5.

According to a preferred embodiment of the present invention, said serine and hydrochloric acid are present in a molar ratio ranging from about 1:2 to about 1:12.5, preferably from about 1:4.5 to about 1:8.5.

According to a preferred embodiment of the present invention, said threonine and hydrochloric acid are present in a molar ratio ranging from about 1:2 to about 1:12.5, preferably from about 1:4.5 to about 1:8.5.

According to a preferred embodiment of the present invention, said valine and hydrochloric acid are present in a molar ratio ranging from about 1:2 to about 1:12.5, preferably from about 1:4.5 to about 1:8.5.

According to a preferred embodiment of the present invention, said amino acid comprises a combination of at least two of the following amino acids: alanine, asparagine, aspartic acid, cysteine, glutamic acid, glycine, histidine, leucine, lysine, methionine, proline, serine, threonine or valine, where the molar amount of the amino acids present ranges from about 1:2 to about 1:12.5 of the molar amount of hydrochloric acid present. Preferably, the molar amount of amino acids present ranges from 1:4.5 to 1:8.5 of the molar amount of hydrochloric acid present.

According to a preferred embodiment of the present invention, said method further comprises a step of testing said rock formation to assess the characteristics thereof prior to injecting said modified acid therein.

According to a preferred embodiment of the present invention, said the molar ratio of the modified acid composition is adjusted to optimize a wormholing capacity thereof based on the type of rock formation being acidized.

According to a preferred embodiment of the present invention, said wormholing capacity is a function of the length of the penetration in the rock formation and the surface area created by the wormholes.

It is known that in the oil and gas industry, in the production phase, the wormholes created during matrix acidizing become channels for the hydrocarbons located in the reservoir oil to reach the wellbore. Matrix acidization and more specifically the creation of wormholes allows for an improvement in the permeability of the rock near the wellbore, and consequently an improvement in oil production.

The inventors have found that certain modified acid compositions yield advantageous wormholing capacity versus the conventional hydrochloric acid treatment. To the inventors'knowledge the potential for carbon capture and storage or sequestration is relevant as a function depth of reach in a formation in combination with wormholing surface area creation through the injection of a modified acid composition down a wellbore.

Wormholing capacity is the ability of an acidic composition to perform wormholing in a rock formation and evaluating the various abilities of performance of the acid within a specific type of formation. One of the parameters referred to in wormholing capacity is the depth of reach into the formation. This is essentially defined as the length traveled by the injected acid inside a rock formation as a result of a treatment (matrix acidization). It is desirable to have deep penetration into a rock formation so as to maximize the value derived from the wellbore. Since wells are expensive to drill, it is desirable to have a matrix acidization which maximizes the penetration of the acid so as to leave as little space between two wellbores as possible and therefore maximize the well value. Another parameter of importance when considering wormholing capacity of an acidic composition is the propensity of the latter to form a large network of very small wormholes, even more preferably needle-like wormholes. A large network of wormholes in a rock formation results in an increased surface area versus a less extensive network of wormholes of larger diameter. The surface area of the wormholes created through matrix acidization treatment allows for adsorption of carbon dioxide within the rock formation. The greater the surface area of the wormholes, the greater the capacity of carbon dioxide adsorption by a wellbore.

According to a preferred embodiment of the present invention, the method involves matrix acidization optimization where the wellbore being treated is tested to assess the type of rock formation involved and the porosity of said rock formation. Preferably, the acidic composition is adjusted, modified altered or the like in order to optimize the acidic composition expected performance in wormholing capacity with the rock formation which is being treated with said acidic composition.

### DETAILED DESCRIPTION OF THE PREFERRED EMBODIMENTS

The description that follows, and the embodiments described therein, is provided by way of illustration of an example, or examples, of particular embodiments of the principles of the present invention.

Matrix acidizing is a type stimulation processes where acid is injected into wellbore in such a way as to penetrate the formation through rock pores where the acid is injected at pressures below fracture pressure.

Conventionally, acid injection can either be employed to perform stimulation operations or to perform clean-up operations (i.e. removing damage, solids located inside the wellbore). The purpose of matrix acidizing is to dissolve any particulates such as sediments, mud solids, casing debris (especially after perforation operations) which will end up plugging up pores located in the rock of the formation and which, when plugged, inhibit the permeability of the formation. Matrix acidizing also increases the diameter of the pores naturally present in rock formation. Increasing their diameter usually has for effect to increase the flow of hydrocarbons (oil and gas). A proper acidizing treatment will avoid near wellbore damage which results in wasted acid as such does not result in deep formation penetration and thus very minimal volume and surface area increase.

Conventional matrix acidizing is geared towards achieving optimum removal of hydrocarbons from a formation and minimizing near wellbore damage.

According to a preferred embodiment of the present invention, the method disclosed herein seeks an optimization (where possible) of a combination of factors including at least the following: the depth of penetration of wormholes in a rock formation; and the surface area of the wormholes created, wherein the wormholes are created by the injection of a modified acid composition down a wellbore and into a rock formation proximate said wellbore.

Conventionally, matrix acidization using hydrochloric acid requires a lot of experience from the operators carrying out the process. Many problems can result from poor operator control of the injection into the wellbore of such an acid. These problems include but are not limited to damage around the wellbore which can be classified as severe damage which generally occurs with a foot of the wellbore; moderate damage which can extend starting around 3 feet from the wellbore. Either one of those two types of damage can greatly affect the porosity of the area proximate the wellbore and thus substantially negatively impact the ability to adsorb carbon dioxide when such is injected into the well in a subsequent step. It is desirable for the acid injection (matrix acidizing step) yield a number of smaller radii wormhole which radiate outwardly from the wellbore. Preferably, the acidic composition will generate a dendritic pattern of the wormholes being created, in essence, in the general shape of a tree root.

According to a preferred embodiment of the method of the present invention, there is provided an injection of a modified acid composition down a wellbore in order to generate wormholes which are small interconnected channels in the rock formation. These wormholes form a system of pores which allows for increased volume of fluid to pass through (liquid or gas). The formation of wormholes is desirable during the production phase in the oil and gas industry as it provides greater flowability of the oil towards the well.

Preferably, the wormholes generated are optimized in terms of a balance between depth of reach into the formation and total surface area created by the formation of said wormholes. Matrix acidization by applying hydrochloric acid cannot achieve a very good balance in this aspect and thus is undesirable.

According to a preferred embodiment of the method of the present invention, certain modified acid compositions are capable of helping an operator achieve an optimal balance between the two factors: depth of reach into the formation and total surface area created by the formation of said wormholes. Preferably, this is achieved by reviewing the type of rock formation being acidized and adapting the modified acid composition to optimize the results.

According to a preferred embodiment of the method of the present invention, the control of the amount of acid being injected into the wellbore for the formation of wormholes is desired as it may be a costly operation in some cases depending on the type of modified acid composition, the location and other factors.

It is desirable to maintain the injection pressure below that of fracturing pressure as the integrity of the rock formation is important when considering the use targeted, i.e. carbon sequestration.

These examples are provided for the purposes of explanation, and not limitation, of those principles and of the invention.

According to a preferred embodiment of the present invention, the modified acid composition comprising at least two components: a first component being an amino acid and a second component being a mineral acid, wherein the amino acid is preferably lysine, and the mineral acid is hydrochloric acid (HCl), wherein the lysine —HCl is the main component in terms of volume and weight percent of the acid composition used in the method of the present invention, and as an amino acid it contains at least one amino group, —NH₂, and one carboxyl group, —COOH. When added to hydrochloric acid a Lewis acid/base adduct is formed where the primary amino group acts as a Lewis base and the proton of the HCL as Lewis acid. The formed adduct greatly reduces the hazardous effects of the hydrochloric acid on its own, such as the fuming effect, the hygroscopicity, and the highly corrosive nature. The excess nitrogen can also act as a corrosion inhibitor at higher temperatures.

In accordance with one of the preferred embodiments of the present invention, the lysine and the hydrogen chloride (HCl) are present in a molar ratio ranging from about 1:3 to about 1:12.5.

In accordance with one of the preferred embodiments of the present invention, the lysine and the hydrogen chloride (HCl) are preferably present in a molar ratio ranging from about 1:4.5 to about 1:9, and more preferably in a molar ratio ranging from more than about 1:4 to about 1:8.5.

The lysine-HCl ratio may be adjusted or determined depending on the intended application and the desired solubilizing ability.

It has been observed that by increasing the ratio of the HCl component, the solubilizing ability will increase while advantageously still providing certain health, safety, environmental and operational advantages over hydrochloric acid on its own.

It is preferable to add the lysine at a molar ratio less than 1:1 to the moles of HCl acid (or any acid). Tests have shown than even adding lysine to HCl in a molar ratio of around 1:2 would neutralize the hydrochloric acid to the point of almost completely removing all of its acidic character. Preferably, the composition according to the present invention comprises at most 1 mole of lysine per 3.0 moles of HCl.

According to a preferred embodiment of the present invention, the lysine-hydrochloride also allows for a reduced rate of reaction when in the presence of carbonate-based materials. This again is due to the stronger molecular bonds associated over what hydrochloric acid traditionally displays.

Further, according to a preferred embodiment of the method of the present invention comprises a composition mainly composed of lysine (which is naturally biodegradable). In accordance with the present invention, testing of the modified acid composition has shown that the lysine hydrochloride (lysine/HCl) has a technical advantage of will maintain the same biodegradability function, something that hydrochloric acid will not on its own.

According to a preferred embodiment of the present invention, there is provided a method of increasing the wormhole volume and surface area in an area proximate a wellbore located within a dolomite formation, said method comprising:
providing a composition comprising a HCl and glycine mixture and water; wherein the molar ratio between the HCl and the glycine ranges from about 1:4 to about 1:8.5;
injecting said composition downhole into said formation at a pressure below the fracking pressure of the formation; and
allowing a sufficient period of time for the composition to contact said formation to create wormholes in said formation.

According to a preferred embodiment of the present invention, there is provided a method of matrix acidizing a hydrocarbon-containing chalk formation, said method comprising:
providing a composition comprising a HCl and lysine mixture and water; wherein the molar ratio between the HCl and the lysine ranges from about 1:4.5 to about 1:8.5,
injecting said composition downhole into said formation at a pressure below the fracking pressure of the formation; and
allowing a sufficient period of time for the composition to contact said formation to create wormholes in said formation.

According to a preferred embodiment of the present invention, there is provided a method of increasing the wormhole volume and surface area in an area proximate a wellbore located within a limestone formation, said method comprising:
providing a composition comprising a HCl and lysine mixture and water; wherein the molar ratio between the HCl and the lysine ranges from about 1:4.5 to about 1:8.5;
injecting said composition downhole into said formation at a pressure below the fracking pressure of the formation; and
allowing a sufficient period of time for the composition to contact said formation to create wormholes in said formation.

According to a preferred embodiment of the present invention, there is provided a method of creating wormholes in an area proximate a wellbore located within a rock formation, said method comprising:
providing a composition comprising a HCl and lysine mixture and water; wherein the molar ratio between the HCl and the lysine ranges from about 1:4.5 and about 1:8.5,
injecting said composition downhole at a desired injection rate into said formation at a pressure below the fracking pressure of the formation; and
allowing a sufficient period of time for the composition to contact said formation to create wormholes in said formation;
   wherein said injection rate is below the injection rate used with a conventional mineral acid and
   wherein said volume and surface area of wormholes thus created exceeds the volume and surface area of wormholes created by injection of HCl under identical conditions.

According to a preferred embodiment of the present invention, there is provided a method of creating wormholes in an area proximate a wellbore located within a chalk formation, said method comprising:
providing a composition comprising a HCl and lysine mixture and water; wherein the molar ratio between the HCl and the lysine ranges from about 1:4.5 and about 1:8.5,
injecting said composition downhole at a desired injection rate into said formation at a pressure below the fracking pressure of the formation; and
allowing a sufficient period of time for the composition to contact said formation to create wormholes in said formation;
   wherein said injection rate is below the injection rate used with a conventional mineral acid and
   wherein said volume and surface area of wormholes thus created exceeds the volume and surface area of wormholes created by injection of HCl under identical conditions.

Preferably, the desired injection rate used is determined by testing said composition at various injection rate into a core sample of said formation; collecting the pore volume to breakthrough data obtained from said testing; plotting a graph of the pore volume to breakthrough data against the injection rate; and determining the optimal injection rate as the lowest point on the plot.

Preferably, the desired injection rate used allows to optimize the surface area created by the wormholes on the rock inside the formation. It was determined that when a modified acid comprising an amino acid and HCl in a molar ratio ranging from about 1:3 to about 1:12.5 is injected at a pressure below fracking pressure can generate wormholes which go deep into the formation so as to maximize the area vs volume ratio and thus optimize the use of the injection of said modified acid composition into said wellbore at a pressure below fracking pressure. Preferably, the amino acid and HCl are present in a molar ratio ranging from about 1:3 to about 1:12.5.

According to a preferred embodiment of the present invention, thousands of abandoned oil wells can be treated with modified acid to obtain wells comprising a multiplicity of wormholes having a high surface area and deep penetration into the rock formation. This type of treatment would allow a well to absorb a substantially higher amount of carbon dioxide compared to an untreated well.

Numerous studies of the wormholing process in carbonate acidizing have shown that the dissolution pattern created by the flowing acid can be characterized as one of three types (1) compact dissolution, in which most of the acid is spent near the rock face; (2) wormholing, in which the dissolution advances more rapidly at the tips of a small number of highly conductive micro-channels, i.e. wormholes, than at the surrounding walls; and (3) uniform dissolution. The dissolution pattern that is created depends on the type of acidic composition used and the interstitial velocity, which is defined as the acid velocity flowing through the porous medium. Interstitial velocity is related to the injection rate (interstitial velocity=injection rate/(area of low porosity). Compact dissolution patterns are created at relatively low injection rates, wormhole patterns are created at intermediate rates and uniform dissolution patterns at high rates.

The interstitial velocity at the wormhole tip controls the wormhole propagation. The optimal acid injection rate to optimize the PVBT (pore volume to breakthrough) is then determined on the basis of a semi-empirical flow correlation. At optimal injection rate, for a given volume, the acidic composition penetrates the furthest into the formation, resulting in the most efficient outcome of for a conventional acid stimulation.

Wormhole structures change from large-diameter at low interstitial velocity to thin wormholes at optimal velocity conditions, to more branched patterns at high interstitial velocity. It has been well-accepted by the oil-and-gas industry that the interstitial velocity yielding wormhole mode if the optimal interstitial velocity, at which for a given volume acid penetrates the furthest into the formation, resulting in the most efficient outcome of acid stimulation. Wormhole structures change from large-diameter at low interstitial velocity to thin wormholes at optimal condition, to more branched pattern at high interstitial velocity.

According to a preferred embodiment of the present invention, one of the main advantages of the method is that through the use of a modified acid comprising lysine and hydrochloric acid in amounts mentioned herein, it is possible to achieve far lower velocities with still superior wormholing pattern.

A series of experimental testing study examined the wormhole formation from a composition of a modified acid comprising lysine and hydrochloric acid in a molar ratio of 1:4.5 compared to a conventional hydrochloric acid composition (15%). It was determined that, under the exact same testing conditions, the wormhole efficiency curve (pore volume to breakthrough vs interstitial velocity) yielded the similar optimal pore volume of breakthrough at about 11% lower value for the modified acid composition and about 18% lower of optimal interstitial velocity compared with HCl.

### TEST PARAMETERS

Two series of matrix acidizing experiments were conducted in order to evaluate the performance of a modified acid comprising lysine and hydrochloric acid at a molar ratio of 1:6.4 vs 15% HCl. The experiments utilized a 90% concentration of lysine and hydrochloric acid at a molar ratio of 1:6.4, and the other set of experiments utilized a 15% solution of HCl.

The experiments were conducted utilizing Indiana limestone cores. All cores were 1.5-inch in diameter and 8-inch in length. The average porosity of the core samples was 14% and the average permeability was 13 mD. The back pressure used in these experiments was 2000 psi. The testing temperature was 180 F (82° C.).

### Test Procedure

The matrix acidizing apparatus consists of a pumping system, an accumulation system, a core containment cell, a pressure maintaining system, a heating system and a data acquisition system. A Teledyne Isco syringe pump was used to inject water and acid at constant rates. A back-pressure regulator was used to maintain the desired minimum system pressure at 2000 psi. Confining pressure was set to 400-500 psi higher than the injection pressure to avoid fluid leaking. Two heating tapes were used to heat the core holder and the injection fluid for the high-temperature tests. During the experiment, the system was first pressurized by injecting water, once the flow reached a steady state; permeability was calculated from the measured pressure differential across the core containment cell. The system was then heated to the experiment temperature. When the full system; fluid, core containment cell and core reached the target temperature, water injection was ceased and acid injection commenced. Injection was ceased when wormholes breached the core and acid injection time was recorded for the breakthrough pore volume calculation. For each experimental condition, 4-6 individual tests were performed with the same temperature and pressure parameters. The only condition that changed was the injection rate. The rate varied in a range until the optimal condition was identified.

The Buijse and Glasbergen (2005) model was utilized to generate the wormhole efficiency relationship by fitting the experimental data obtained. To understand the core flood results, the pore volume to breakthrough was plotted versus interstitial velocity and then applied the Buijse and Glasbergen model to curve-fit the experimental data to identify the optimal injection rate condition.

The preliminary observations of this series of wormhole efficiency testing: the optimal pore volume to breakthrough for the 90% lysine:HCl composition is slightly higher than that of 15% HCl; the optimal interstitial velocity for lysine and hydrochloric acid at a molar ratio of 1:6.4 (90% concentration) is in the comparable range of that of 15% HCl; and the pore volume to breakthrough for higher injection rates (above optimal) is similar for both systems.

Two more series of matrix acidizing experiments were conducted in order to evaluate the performance of a 90% composition of lysine:HCl in a 1:4.5 ratio and a 50% composition of lysine:HCl in a 1:6.5 ratio vs 15% HCl. A first set of experiments utilized a 90% composition lysine:HCl in a 1:4.5 ratio with 0.3 vol % of a corrosion inhibitor, a second set of experiments utilized a 50% composition of lysine:HCl in a 1:6.5 ratio; and the third set of experiments utilized a 15% solution of HCl.

The experiments were conducted utilizing Kansas Chalk cores. All cores were 1.5-inch in diameter and 6-inch in length. The average porosity of the core samples was 33% and the average permeability was 1.57 mD. The back pressure used in these experiments was 1200 psi. The testing temperature was 70 F (21° C.). The chalk cores were selected as they help in simulating the geology encountered most commonly in oilfields in the North Sea.

Increasing confining pressure due to the need of using a higher back pressure at higher temperatures cracked the chalk cores, as such the tests were conducted at ambient temperature. Previously published laboratory testing has shown little variance in results with higher temperatures.

### Core Properties

The cores utilized for testing were 1.5 in. diameter and 6 in. long. The Kansas Chalk had an average permeability of 1.57 md and porosity of 33%.

To obtain and understand the core flood results, the pore volume to breakthrough was plotted versus interstitial velocity and then applied the Buijse and Glasbergen model to curve-fit the experimental data to identify the optimal condition. The optimal condition obtained for the three sets of experiments with Buijse and Glasbergen equation were obtained.

### Conclusions

The 90% lysine:HCl composition has the same level of pore volume to breakthrough (PVBT) compared with HCl 15%, with the optimal interstitial velocity about 50% lower than for HCl 15%. This data indicates that, at low injection rates (below the optimal injection rate for 15% HCl), the 90% lysine:HCl composition has a significant lower pore volume to breakthrough (PVBT). The pore volume to breakthrough and interstitial velocity results for the 50% lysine:HCl composition (in a 1:6.5 ratio), although somewhat higher than those of the 15% HCl, are marked improvements over other known retarded acid compositions. The results for the 50% lysine:HCl compostion (in a 1:6.5 ratio) also indicate that the optimum concentration of a 1:6.5 composition for a more appropriate comparison with 15% HCl would be a dilution to 75% of the 1:6.5 concentrate. In that case, the acid content would be similar to that of the 15% HCl composition and of the 90% lysine:HCl composition (in a 1:4.5 ratio).

The Buijse-Glasbergen wormhole propagation model uses the optimum values obtained from the curve fit to calculate the wormhole propagation velocity, which is then used to calculate the wormhole length. The longer the wormhole, the better the stimulation outcome.

As injection proceeds, wormholes become longer, and wormhole propagation rate decreases. For long contact (such as horizontal wells), lower interstitial velocity sometimes is unavoidable, and the acid system (acidic composition used in the injection) that has lower optimal interstitial velocity but comparable pore volume of breakthrough will have a major advantage.

A series of test carried out allowed to determine that comparing the wormhole propagation at various rates of injection using both 15% HCl and the 90% lysine:HCl (1:4.5 ratio) composition. The results indicated that the 90% lysine:HCl (1:4.5 molar ratio) composition excelled as a retarded acid but also produced an increased wormhole penetration at both injection rates tested on a wellbore with 0.4-ft radius and 1000-ft contact length. Additionally, it was found that there was additional skin reduction using the 90% lysine:HCl (1:4.5 molar ratio) composition due to the improvement in wormhole propagation. Typically, modified acids would have higher pore volume of breakthrough (PVBT) and, from a wormholing point of view, retarded acids (like gelled or emulsified HCl) typically do not have an advantage on wormhole propagation. However, a lysine:HCl composition (as used in the preferred methods of the present invention) did not exhibit this disadvantage as a retarded (or modified) acid. Prior testing has shown that experimental wormhole efficiency tests utilizing a 90% lysine:HCl (in a 1:4.5 molar ratio) composition yielded the following: the optimal interstitial velocity for the lysine:HCl composition is almost 50% lower than 15% HCl providing a clear advantage over conventional HCl acid systems by allowing operators to stimulate formations under optimal conditions without the need to resort to extremely high injection rates. The lysine:HCl composition showed a comparable optimum PVBT in comparison to the 15% HCl system tested. Thus, combined with low optimal interstitial velocity, the modified acid composition used according to a preferred method of the present invention can improve wormholing generation in a wellbore in such a way as to substantially increase the volume and surface area to absorb and retain carbon dioxide in formation without causing near wellbore damage or other undesirable damage to either the wellbore, the formation or the wormholes.

While the foregoing invention has been described in some detail for purposes of clarity and understanding, it will be appreciated by those skilled in the relevant arts, once they have been made familiar with this disclosure that various changes in form and detail can be made without departing from the true scope of the invention in the appended claims.

1-16. (canceled)

17. A method to increase the volume and surface area of a wellbore, said method comprising:
providing a wellbore located within a rock formation;
providing a modified acid composition comprising at least two components: a first component being an amino acid and a second component being a mineral acid;
wherein said first component and second component being present in a molar ratio ranging from 1:2 to 1:12.5;
injecting said modified acid composition into said wellbore at a pressure below fracking pressure;
allowing the modified acid composition to be in contact with the rock formation for a period of time long enough to allow the modified acid composition to create a series of wormholes and consequently increase the surface area fluidly connected to said wellbore to enhance the absorption capacity of carbon dioxide injected into said wellbore.

18. The method according to claim 17, where said amino acid is selected from the group consisting of: alanine, asparagine, aspartic acid, cysteine, glutamic acid, glycine, histidine, leucine, lysine, methonine, proline, serine, threonine, valine and combinations thereof.

19. The method according to claim 17, wherein said amino acid is lysine.

20. The method according to claim 17, wherein said mineral acid is hydrochloric acid.

21. The method according to claim 19, wherein said lysine is present in a molar ratio ranging from about 1:3 to about 1:12.5 with respect to the hydrochloric acid.

22. The method according to claim 17, wherein said rock formation is selected from the group consisting of: limestone formation; dolomite formation and chalk formation.

23. The method according to claim 17, wherein said rock formation is a chalk formation.

24. The method according to claim 17, wherein said method further comprises a step of testing said rock formation to assess the characteristics thereof prior to injecting said modified acid composition therein.

25. The method according to claim 17, wherein the molar ratio of the modified acid composition is adjusted to optimize a wormholing capacity thereof based on the type of rock formation being acidized.

26. The method according to claim 25, wherein the wormholing capacity is a function of the length of the penetration in the rock formation and the surface area created by the wormholes.

27. A modified acid composition comprising at least two components:
a first component being an amino acid; and
a second component being a mineral acid;
wherein said first component and second component being present in a molar ratio ranging from 1:2 to 1:12.5.

28. The modified acid composition as claimed in claim 27, wherein said amino acid is selected form the group consisting of: alanine, asparagine, aspartic acid, cysteine, glutamic acid, glycine, histidine, leucine, lysine, methonine, proline, serine, threonine, valine and combinations thereof.

29. The modified acid composition as claimed in claim 27, wherein said amino acid is lysine.

30. The modified acid composition as claimed in claim 27, wherein said mineral acid is hydrochloric acid.

31. The modified acid composition as claimed in claim 27, wherein said amino acid is present in a molar ratio ranging from about 1:3 to about 1:12.5 with respect to the mineral acid.
